(19) United States
(12) Patent Application Publication
(10) Pub. No.: US 2018/0097410 A1
(43) Pub. Date: Apr. 5, 2018

(54) STATOR OF A MOTOR VEHICLE STARTER PROVIDED WITH A PERMANENT MAGNET FORMING A PLURALITY OF POLES

(71) Applicant: VALEO EQUIPEMENTS ELECTRIQUES MOTEUR, Creteil Cedex (FR)

(72) Inventors: Jean-Marc DUBUS, Combs La Ville (FR); Nicolas LABBE, Lyon (FR)

(73) Assignees: VALEO EQUIPEMENTS ELECTRIQUES MOTEUR, Creteil Cedex (FR); VALEO EQUIPEMENTS ELECTRIQUES MOTEUR, Creteil Cedex (FR)

(21) Appl. No.: 15/565,110

(22) PCT Filed: Apr. 7, 2016
(86) PCT No.: PCT/FR2016/050791

§ 371 Date: Oct. 6, 2017

(30) Foreign Application Priority Data
Apr. 7, 2015 (FR) 1552947

(51) Int. Cl. H02K 1/17; H02K 1/02; H02K 21/14; H01F 13/00; H02K 15/03; H01F 41/02; H01F 7/02

(52) U.S. Cl. CPC H02K 1/17; H02K 1/02; H02K 21/14; H02K 23/04; H02K 15/03; H01F 41/0273; H01F 7/0268; H01F 13/003

(57) ABSTRACT

The invention relates to a starter for a motor vehicle heat engine. The starter includes a rotary electric machine provided with a stator (3). The stator (3) includes a magnetic pole assembly wherein a permanent magnet (5) forms at least two poles of the magnetic pole assembly. The permanent magnet may have a cylindrical shape and be molded from a combination of magnetic particles embedded within a non-magnetic binder. Using this structure, the number of magnets used to create the stator may be limited in number, thereby limiting the necessary assembly steps to create the stator.

The present invention relates to a stator of a motor vehicle starter provided with a permanent magnet forming a plurality of poles.

Motor vehicle starters are known that are provided with a stator, or inductor, comprising several permanent magnets and a rotor, or armature, having a body of cylindrical shape, and a winding formed from conducting wires.

As is known per se, the inductor comprises a metal yoke, the inner face of which supports a plurality of permanent magnets intended to produce an induction field. The permanent magnets are configured as cylindrical segments, with angular distribution at regular intervals inside the yoke, and separated uniformly from the armature by a radial air gap. The permanent magnets are generally fixed on the inner face of the yoke by means of clamps extending in the longitudinal direction in the spaces provided between the permanent magnets.

Moreover, the rotor body consists of a stack of plates having longitudinal slots in which the wires of the winding are inserted, consisting for example of pin-shaped conductors. The rotor is in addition provided with a collector comprising a plurality of contact pieces connected electrically to the wires of the winding.

The invention aims to facilitate the production of a starter of this kind, by proposing a starter for a motor vehicle heat engine comprising:

a rotating electrical machine provided with a stator, said stator comprising

a set of magnetic poles,

characterized in that a permanent magnet forms at least two poles of the set of said magnetic poles.

Thus, the invention makes it possible to limit the number of magnets used in the stator, which limits the number of assembly operations to be carried out on the assembly line during manufacture of the starter.

According to one embodiment, said permanent magnet forms all of said magnetic poles. Such a configuration makes it possible to create a uniform induction field in the air gap.

According to one embodiment, the magnet comprises various directions of the magnetic polarization field. In this case, the magnet comprises at least two directions forming an angle of at least 90° between these two directions.

“Magnet” means a single solid component that may comprise several directions of magnetization. In other words a magnet may not comprise several magnets (several pieces of magnets) joined together and forming a block.

According to one embodiment, said permanent magnet has a cylindrical shape.

According to one embodiment, said permanent magnet is a single piece.

According to one embodiment, said stator further comprises a yoke. The yoke essentially provides mechanical support of the stator.

According to one embodiment, said permanent magnet is a moulded magnet based on magnetic particles embedded in a binder made of a non-magnetic material.

Thus, the magnet already has magnetic domains that are aligned during overmoulding and therefore prior to assembly thereof in the motor. This has the advantage that it is possible to assemble the already oriented magnet in the motor.

According to one embodiment, said binder has a melting point equal to or above the Curie point of said magnetic particles.

According to one embodiment, said binder is made of a plastic.

According to one embodiment, said magnetic particles are made of neodymium-iron-boron.

According to one embodiment, the material used preferably has a remanence in the order of 0.6 tesla. The method of measurement for the remanence of the material is that described in standard NFEN60404-5.

According to one embodiment, said magnetic particles are made of samarium-iron-nitrogen.

According to one embodiment, said machine comprises a rotor separated from said stator by an air gap, said magnetic particles being magnetized in such a way that a magnetic field in said air gap varies sinusoidally along a circumference of said air gap.

According to one embodiment, between two central parts of two consecutive poles, the direction of the magnetic field generated by said permanent magnet gradually varies along a circumference of said stator,

between a substantially radial orientation in a first direction,

reaching a substantially orthoradial orientation in a zone located roughly in the middle of the two central parts, and

continues to vary progressively, reaching a substantially radial orientation in a second direction opposite to said first direction.

According to one embodiment, between the two central parts of two consecutive poles, the direction of the magnetic field varies following a curved direction.

According to one embodiment, said permanent magnet is magnetized according to a configuration of the Halbach type.

In this case the plastic-bonded magnets are anisotropic, i.e. the magnetic domains are aligned during overmoulding in order to obtain the Halbach structure.

According to one example, the level of Br is fixed at 0.6-0.7T while remaining ANISOTROPIC. For this, the loading rate of the material of the plastic-bonded magnets is varied.

Injection of the binder—powder mixture, for example NdFeB, is performed under a field in order to orient the magnetic domains to preserve the anisotropy and obtain the Halbach structure.

The invention also relates to a starter for a motor vehicle heat engine comprising:

an electrical machine provided with a stator, said stator comprising

a set of magnetic poles,

characterized in that, at least between two central parts of two consecutive poles, the direction of the magnetic field of a permanent magnet gradually varies along a circumference of said stator,

between a substantially radial orientation in a first direction,

reaching a substantially orthoradial orientation in a zone located roughly in the middle of the two central parts, and

continues to vary progressively, reaching a substantially radial orientation in a second direction opposite to said first direction.

Thus, in contrast to what is recommended, the starter has a Halbach oriented from the outside of the stator towards the armature. In fact, this makes it possible to improve the efficiency of the starter owing to the very high level of the field H of reaction of the armature.

The starter is moreover of the brush type.

Furthermore, the gradual variation of the magnetic field means that the direction of the magnetic field in the magnet is constantly varying relative to a radial plane passing through one of the central parts of the two poles.

Furthermore, the direction of the magnetic field has, in one zone, a direction that is substantially orthoradial relative to a radial plane (perpendicular to the axis comprising radii of the axes on 360°) passing through this zone and then gradually the direction of the magnetic field varies on either side of this zone relative to this plane in the direction from the central parts of two poles towards a radial direction and in that the sense of the direction of the magnetic field varies in the same way.

Furthermore, between the two central parts of the two poles, the variations of the magnetic field together form a concave shape viewed from the interior of the stator.

The invention will be better understood on reading the description given hereunder and on examining the accompanying figures. These figures are only given for purposes of illustration and do not limit the invention in any way.

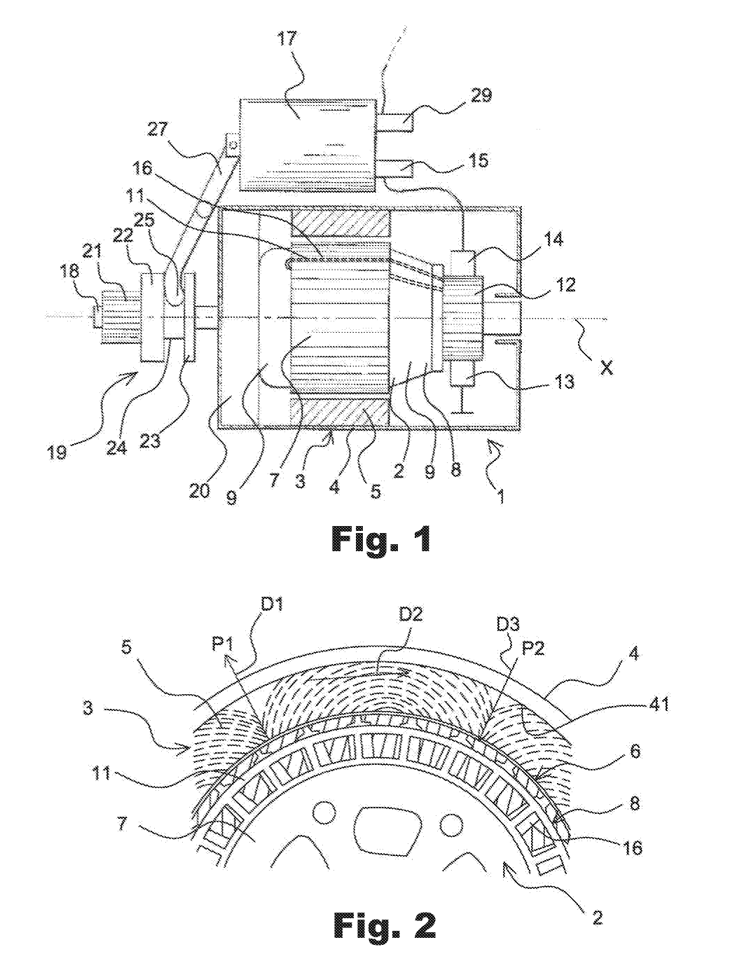

FIG. 1 is a schematic side view of a starter according to the present invention;

FIG. 2 is a partial cross-sectional view of the rotor and stator of the electrical machine that is part of the starter in FIG. 1;

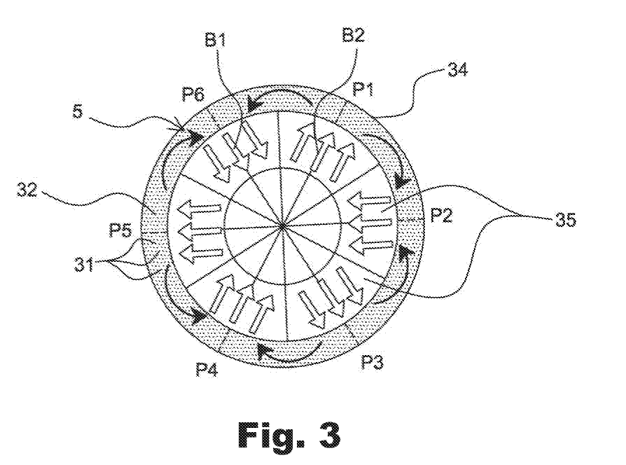

FIG. 3 shows the device for producing a single-piece permanent magnet of the stator according to the present invention.

Elements that are identical, similar or analogous keep the same references from one figure to another.

FIG. 1 shows, schematically, a starter 1 for an internal-combustion engine of a motor vehicle. This direct-current starter 1 comprises, on the one hand, a rotor 2, also called armature, which is able to rotate about an axis X, and on the other hand, a stator 3, also called inductor, positioned around the rotor 2. The rotor 2 is separated from the stator 3 by an air gap 6. In the example illustrated, the rotating electrical machine formed by the stator 3 and the rotor 2 is of the six-pole type. As a variant, the machine could be of the four-pole type.

This stator 3, described in more detail below, comprises a yoke 4 bearing a permanent magnet 5 forming a set of poles.

The rotor 2 comprises a rotor body 7 and a winding 8 wound in slots in the rotor body 7. The rotor body 7 consists of a stack of plates having longitudinal slots. To form the winding 8, pin-shaped conducting wires 11 (more easily seen in FIG. 2) are threaded inside the slots 16 generally on two separate layers. The winding 8 forms buns 9 on either side of the rotor body 7.

The rotor 2 is provided, at the back, with a collector 12 comprising a plurality of contact pieces connected electrically to the conducting elements, consisting here of the pins 11 of the winding 8.

A group of brushes 13 and 14 is provided for electrical supply to the winding 8, one of the brushes 13 being earthed on the starter 1 and the other brush 14 being connected to a terminal 15 of a contactor 17. The brushes are for example four in number.

The brushes 13 and 14 will rub against the collector 12 when the rotor 2 is rotating, which makes it possible to supply the rotor 2 by commutation of the electric current in sections of the rotor 2.

The contactor 17 comprises, besides the terminal 15 connected to the brush 14, a terminal 29 connected, via an electrical connection element, to an electrical supply of the vehicle, notably a battery.

The starter 1 further comprises a starter drive assembly 19 mounted sliding on a drive shaft 18 and can be made to rotate about the axis X by the rotor 2.

A speed reducing assembly 20 is interposed between a shaft of the rotor 2 and the drive shaft 18. The starter drive assembly 19 comprises a drive element formed by a pinion 21 that is intended to engage with a drive member of the heat engine, such as a starter ring gear. As a variant, it would be possible to use a pulley system.

The starter drive assembly 19 further comprises a free wheel 22 and a pulley washer 23, together defining a groove 24 for receiving the end 25 of a fork 27.

The fork 27 is actuated by the contactor 17 to displace the starter drive assembly 19 relative to the drive shaft 18, along the axis X, between a first position in which the starter drive assembly 19 drives the heat engine via the drive pinion 21, and a second position in which the starter drive assembly 19 is disengaged from the starter ring gear of the heat engine. On activation of the contactor 17, an internal contact plate (not shown) makes it possible to establish a connection between the terminals 15 and 29 in order to supply power to the electric motor. This connection will be cut on deactivation of the contactor 17.

As can be seen in FIG. 2, the stator 3 comprises a magnet 5 that is of cylindrical shape. This magnet 5 forms the set of poles P1-P6 of the stator 3, which allows a uniform induction field to be created in the air gap 6. Alternatively, magnet 5 has the shape of a portion of a cylinder so as to form two or more poles of the set of magnetic poles. Thus, generally, magnet 5 will be able to travel over an angular portion of a cylinder with a value of (360/K)*N degrees, where K is the total number of poles of the stator 3 and N is the number of poles formed by magnet 5, equal to at least two and at most K. In the example, K has a value of 6 but could as a variant have some other value, for example equal to 4 or greater than 6. Magnet 5 is of a single piece, i.e. there is crystallographic continuity in the material of the magnet that forms the different poles P1-P6.

In this case, as is illustrated in FIG. 3, magnet 5 is a moulded magnet based on magnetic particles 31 embedded in a binder 32 made of a non-magnetic material. For this purpose, the binder 32 is heated to its melting point, which is equal to or above the Curie point of the magnetic particles 31. It may be mentioned here that the Curie point is the temperature at which the magnetic particles 31 are demagnetized.

The binder 32 is placed in a mould 34 of cylindrical shape that surrounds a core made up of a set of permanent magnets 35, the number of which corresponds to the number of poles of the stator 3. Each of the magnets 35 is magnetically oriented radially. Two consecutive magnets 35 have magnetic field orientations B1, B2 that are opposite to one another.

The magnetic particles 31 (initially demagnetized) are put inside the mould 34 and are magnetized following the configuration of the magnetic flux generated by the magnets 35 while the temperature inside the mould 34 decreases, which causes gradual hardening of the binder 32. At the end of the process, the magnetized particles 31 are trapped by the binder 32 while having been magnetized in such a way that between two central parts of two consecutive poles P1-P6, the direction of the magnetic field generated by the magnet 5 gradually varies along a circumference of the stator 3.

More precisely, as can be seen in FIG. 2, between the central parts of the two consecutive poles P1 and P2, the direction of the magnetic field varies between a substantially radial orientation D1 in a first direction, for example from the air gap 6 to the yoke 4, to reach a substantially orthoradial orientation D2 in a zone located roughly in the middle of the two central parts of the two consecutive poles P1 and P2 and continues to vary gradually, reaching a substantially radial orientation D3 in a second direction opposite to the first direction, for example from the yoke 4 to the air gap 6 of the machine. The change in the direction of the magnetic field is of course the opposite in the case when we begin with a radial orientation from the yoke 4 to the air gap 6.

Between the two central parts of two consecutive poles P1-P6, the direction of the magnetic field varies following a roughly curved direction.

In other words, the cylindrical magnet 5 is magnetized according to a configuration of the Halbach type.

In such a configuration, the magnetic field in the air gap 6 varies sinusoidally along the circumference of the air gap 6 of the electrical machine.

In one embodiment example, the binder 32 consists of a plastic, and the magnetic particles 31 can be made of neodymium-iron-boron or of samarium-iron-nitrogen. The material used preferably has a remanence in the order of 0.6 tesla. As a variant, the magnetic particles 31 and the binder 32 can be made of any other material suitable for the application. The value of the remanence can also be adapted as a function of the magnetic power required from the electrical machine.

It should be noted that the yoke 4, against the inner face 41 of which the magnet 5 is placed, essentially provides mechanical support of the stator 3, as the level of the magnetic fields that pass through the yoke 4 is very low. The magnet 5 is generally fixed on the inner face 41 of the yoke 4 by means of one or more clamps. The fixation of the clamps notably provides axial and radial holding of the magnet 5 in the yoke 4 by opposing the mechanical forces (vibrations, shocks), and the forces of magnetic attraction during operation of the engine. In the case when several magnets 5 are used, the clamps additionally guarantee spacing between the magnets 5 to create a uniform induction field in the air gap 6.

Of course, the foregoing description is given purely as an example and does not limit the scope of the invention, which would not be left if the various elements are replaced with any others that are equivalent.

1. Starter (1) for a motor vehicle heat engine, comprising:
a rotating electrical machine provided with a stator (3), said stator (3) comprising
a set of magnetic poles (P1-P6),
wherein a permanent magnet (5) forms at least two poles of the set of said magnetic poles (P1-P6) and wherein said permanent magnet (5) is a moulded magnet based on magnetic particles (31) embedded in a binder (32) made of a non-magnetic material.

2. Starter according to claim 1, wherein said permanent magnet (5) forms the set of said magnetic poles (P1-P6).

3. Starter according to claim 1, wherein said permanent magnet (5) is of a cylindrical shape.

4. Starter according to claim 1, wherein said permanent magnet (5) is made in one piece.

5. Starter according to claim 1, wherein said stator (3) further comprises a yoke (4).

6. Starter according to claim 2, wherein said permanent magnet (5) is of a cylindrical shape.

7. Starter according to claim 1, wherein said binder (32) has a melting point equal to or above the Curie point of said magnetic particles (31).

8. Starter according to claim 1, wherein said binder (32) is made of a plastic.

9. Starter according to claim 1, wherein said magnetic particles (31) are made of neodymium-iron-boron.

10. Starter according to claim 1, wherein said magnetic particles (31) are made of samarium-iron-nitrogen.

11. Starter according to claim 1, wherein said machine comprises a rotor (2) separated from said stator (3) by an air gap (6), and wherein said magnetic particles (31) are magnetized so that a magnetic field in said air gap (6) varies sinusoidally along a circumference of said air gap (6).

12. Starter according to claim 1, wherein, between two central parts of two consecutive poles (P1-P6), the direction of a magnetic field generated by said permanent magnet (5) gradually varies along a circumference of said stator,
between a substantially radial orientation (D1) in a first direction,
reaching a substantially orthoradial orientation (D2) in a zone located roughly in the middle of the two central parts, and
continues to vary gradually, reaching a substantially radial orientation (D3) in a second direction opposite to said first direction.

13. Starter according to claim 12, wherein, between the two central parts of two consecutive poles, the direction of the magnetic field varies following a curved direction.

14. Starter according to claim 1, wherein said permanent magnet (5) is magnetized according to a configuration of the Halbach type.

15. Starter for a motor vehicle heat engine, comprising:
an electrical machine provided with a stator (3), said stator (3) comprising
a set of magnetic poles (P1-P6),
wherein at least between two central parts of two consecutive poles (P1-P6), the direction of the magnetic field of a permanent magnet (5) gradually varies along a circumference of said stator (3),
between a substantially radial orientation (D1) in a first direction,
reaching a substantially orthoradial orientation (D2) in a zone located roughly in the middle of the two central parts, and
continues to vary gradually, reaching a substantially radial orientation (D3) in a second direction opposite to said first direction.

16. Starter according to claim 2, wherein said permanent magnet (5) is made in one piece.

17. Starter according to claim 3, wherein said permanent magnet (5) is made in one piece.

18. Starter according to claim 2, wherein said stator (3) further comprises a yoke (4).

19. Starter according to claim 3, wherein said stator (3) further comprises a yoke (4).

20. Starter according to claim 4, wherein said stator (3) further comprises a yoke (4).
